(19) United States
(12) Patent Application Publication
(10) Pub. No.: US 2024/0095713 A1
(43) Pub. Date: Mar. 21, 2024

(54) METHOD, CLIENT DEVICE AND POS TERMINAL FOR OFFLINE TRANSACTION

(71) Applicant: Wing Lok Keith LAU, Hong Kong (HK)

(72) Inventor: Wing Lok Keith LAU, Hong Kong (HK)

(21) Appl. No.: 18/520,121

(22) Filed: Nov. 27, 2023

Related U.S. Application Data
(63) Continuation of application No. 16/681,365, filed on Nov. 12, 2019.

(51) Int. Cl. G06Q 20/32; G06Q 20/20; G06Q 20/34

(52) U.S. Cl. CPC G06Q 20/3274; G06Q 20/20; G06Q 20/351

(57) ABSTRACT

Provided is method, client device and POS terminal for offline transaction. The method comprises: obtaining a transaction token in advance from a payment server, wherein the transaction token includes an expiry date; displaying a code for transaction for a POS terminal to scan the code when the transaction is performed with the POS terminal; the code includes the transaction token and a last transaction record; receiving a new transaction record via Bluetooth, sent by the POS terminal; wherein the new transaction record is generated by the POS terminal according to the transaction amount and the last transaction record after verifying that the transaction token is in a valid state; the valid state includes the expiry date being later than the current time; and storing the new transaction record for performing the next transaction with a POS terminal. The invention can provide a safe and convenient solution for the offline purchase transaction of the mobile phone users on the client end. There is no need to install a special terminal for the merchant to top-up the virtual card, and the cardholder can easily top-up the card. Moreover, the offline operation can be realized, and the recharge and consumption operation can also be completed in some places where the wireless network coverage is not good.

### CROSS-REFERENCE TO RELATED APPLICATION(S)

This application is a continuation of the U.S. application Ser. No. 16/681,365 filed on Nov. 12, 2019, and entitled “METHOD, CLIENT DEVICE AND POS TERMINAL FOR OFFLINE TRANSACTION”.

### TECHNICAL FIELD

The invention relates to the field of communication technology, in particular to a method, a client device, a POS terminal and a storage medium for offline transaction.

### BACKGROUND

Regarding mobile payment, the prior arts generally use Near Field Communication (NFC) for payment. However, the NFC configuration costs are high, and it's not very popular for mobile devices with NFC. Therefore, it is limited to pay by NFC.

In addition, other related technologies can be used for account top-up. There are two methods for carrying out top-up in general: First, the cardholder pays the merchant directly and provides account information to the merchant, and the merchant top-ups the corresponding account on the merchant's terminal. Second, the cardholder logs in to the online platform on his mobile device, connects to the server that provides the top-up service, and top-ups the corresponding account on the online platform. However, for the first one, the merchant is required to install a dedicated terminal. In the initial stage of the system deployment, the number of cardholders who use the payment platform is still small, and it is difficult to find enough merchants to install the terminal, which makes it difficult for the cardholder to find a place to top-up. For the second one, cardholders need to operate online during the top-up process. But, in some undeveloped countries, wireless network coverage is poor, and places that can be top-up are limited. Therefore, the second top-up cannot be widely used.

### SUMMARY

It is an object of the present invention to provide a method, a client device and a POS terminal for offline transaction to solve one or more of the technical problems set forth above in the prior art.

Embodiments of the present invention provide a method for offline transaction, executed by a client device, comprising:
obtaining a transaction token in advance from a payment server, wherein the transaction token includes an expiry date;
displaying a code for transaction for a POS terminal to scan the code when the transaction is performed with the POS terminal; the code includes the transaction token and a last transaction record;
receiving a new transaction record via Bluetooth, sent by the POS terminal; wherein the new transaction record is generated by the POS terminal according to the transaction amount and the last transaction record after verifying that the transaction token is in a valid state; the valid state includes the expiry date being later than the current time; and
storing the new transaction record for performing the next transaction with a POS terminal.

Embodiments of the present invention provide a method for offline transaction, executed by a POS terminal, and comprising:
scanning, by the POS terminal, a code for a transaction displayed by the client device to obtain information of the code; wherein the information of the code includes a transaction token and a last transaction record, the transaction token is obtained by the client device in advance from a payment server, and the transaction token includes an expiry date;
verifying that the transaction token is in a valid state;

If the transaction token is valid, generating a new transaction record according to the transaction amount input by a merchant to the POS terminal and the last transaction record; wherein the valid state includes that the expiry date is later than the current time; and
sending the new transaction record to the client device via Bluetooth for preforming by the client device for the next transaction with a POS terminal.

Embodiments of the present invention provide a client device, comprising:
a memory module, configured to store a transaction token obtained in advance from a payment server; wherein the transaction token includes an expiry date;
a display screen, configured to display a code for transaction for the POS terminal to scan the code when the transaction is performed with the POS terminal; the code includes the transaction token and the last transaction recording;
a Bluetooth, configured to receive a new transaction record sent by the POS terminal; wherein the new transaction record is generated by the POS terminal according to the transaction amount and the last transaction record after verifying that the transaction token is in a valid state; the valid state includes the expiry date being later than the current time; and

The memory module, further configured to store the new transaction record for perform the next transaction with a POS terminal.

Embodiments of the present invention provide a POS terminal, comprising:
a two-dimensional code scanner, configured to scan a code for a transaction displayed by the client device to obtain information of the code; wherein the information of the code includes a transaction token and a last transaction record, the transaction token is obtained by the client device in advance from a payment server, and the transaction token includes an expiry date;
a processor, configured to verify that the transaction token is in a valid state; if the transaction token is valid, generates a new transaction record according to the transaction amount input by a merchant to the POS terminal and the last transaction record; wherein the valid state includes that the expiry date is later than the current time; and
a Bluetooth, configured to send the new transaction record to the client device for the client device to perform next transaction with a POS terminal.

Embodiments of the present invention also provide a computer readable storage medium storing a computer program. The method provided by any one of the above embodiments is implemented when the program is executed by a processor.

The embodiment of the invention can provide a safe and convenient implementation scheme for the offline transaction of the client phone user, and the card holder can conveniently perform the top-up without the merchant installing a dedicated terminal device. Moreover, the present invention can realize offline operation, and can perform top-up operation in places where wireless coverage is not good.

### BRIEF DESCRIPTION OF THE DRAWINGS

FIG. 1 is a schematic diagram for an embodiment of a POS terminal provided by the present invention.

FIG. 2 is a schematic diagram of an embodiment of a client device (client handset) provided by the present invention;

FIG. 3 is a schematic diagram of an embodiment of a payment server provided by the present invention;

FIG. 4 is a schematic diagram of an embodiment of a payment system provided by the present invention;

FIG. 5 is a schematic flow chart of an embodiment of a method for offline transaction provided by the present invention; FIG.

FIG. 6 is a schematic flow chart of an embodiment of a method for offline transaction provided by the present invention.

### DETAILED DESCRIPTION OF THE INVENTION

The invention will be described in detail below with reference to the drawings and embodiments.

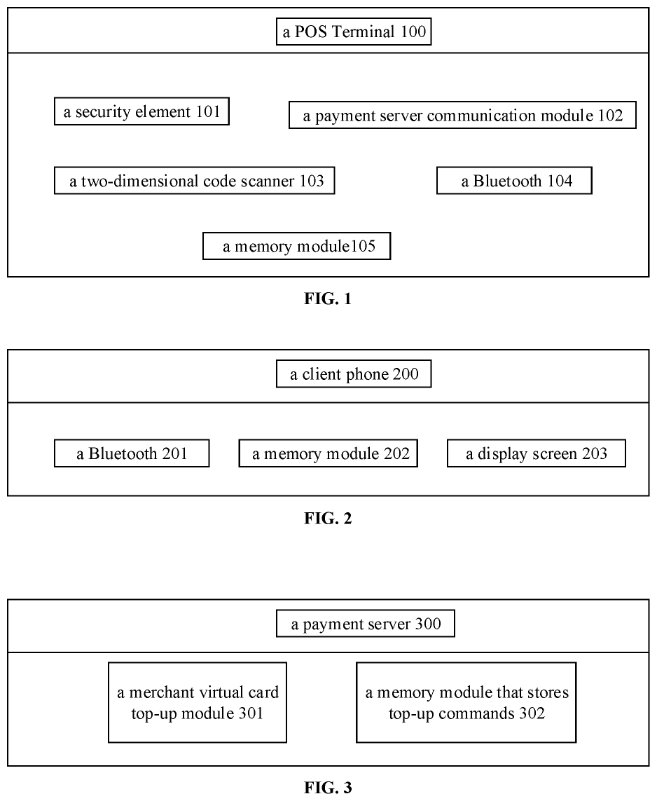

As shown in FIG. 1, a POS terminal 100 may include a secure element 101, a payment server communication module 102, a two-dimensional code scanner 103, a Bluetooth 104, and a memory module 105 for storing top-up commands. The memory module 105 can also be called a top-up command list memory module or a top-up command memory module. The secure element 101 in the POS terminal can record a private key.

As shown in FIG. 2, a client phone 200 may include a Bluetooth 201, a memory module 202, and a display screen 203. The memory module 202 can be used to record transaction tokens, transaction records recorded in a general ledger, and their respective signatures.

As shown in FIG. 3, a payment server 300 may include a merchant virtual card top-up module 301 and a memory module 302 that stores top-up commands. In some embodiments, the payment server 300 can also include a Bluetooth 303. The memory module 302 can also be called a top-up command memory module in a system.

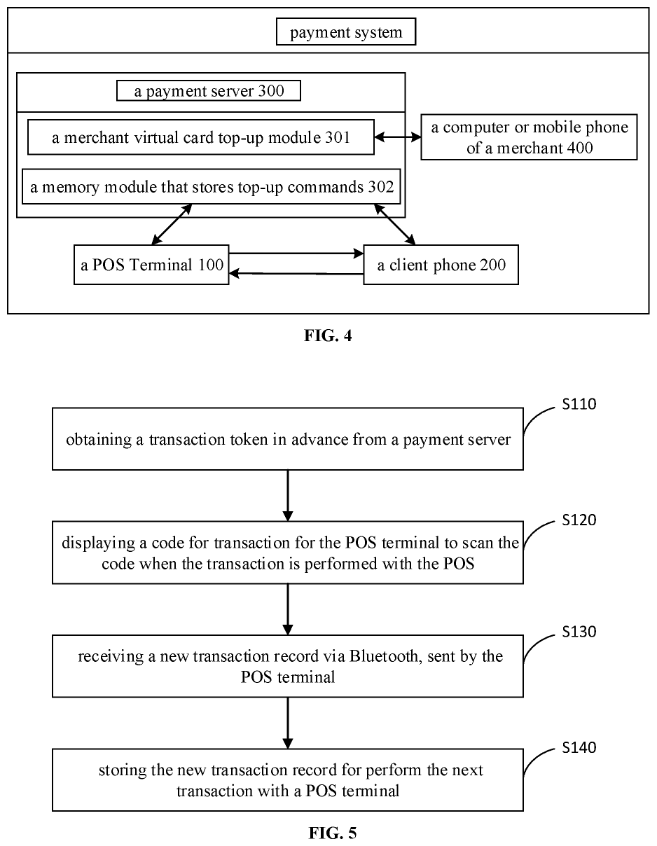

As shown in FIG. 4, an offline mobile payment system proposed by the present invention may include a POS terminal 100, a client phone 200, a payment server 300, and a computer or mobile phone of a merchant 400. Both the client phone and the merchant's computer or mobile phone can communicate with the payment server through the network, and the data communication between the POS terminal and the client phone can be performed through Bluetooth technology or two-dimensional code technology.

The present invention provides an offline transaction method for a POS terminal including a two-dimensional code reader and a Bluetooth. The balance of the wallet can be recorded in the memory module of the mobile phone in a general ledger. The client phone logs into the payment platform through the Internet in advance. After the server of the payment platform authenticates the user profile, the transaction token is sent to the client phone. The memory module of the client phone records the received transaction tokens.

During the transaction between the client phone and the POS terminal, the client phone displays the above transaction token in a two-dimensional code for the POS terminal to read. If the client phone has made a transaction with any POS terminal after receiving the transaction token, the latest transaction record can also be transmitted through the two-dimensional code. After reading the two-dimensional code, the POS terminal generates the latest transaction record and transmits it to the client phone via Bluetooth. The client phone receives the transaction record and records it into the memory module.

In some embodiments, the transaction token described above may include an expiry date. The client phone can always trade offline with the POS terminal before the expiry date. Before the expiry date, the client phone needs to check the transaction record again with the payment server and re-acquire a new transaction token. The new transaction token can provide a new expiry date so that the client phone can continue to perform offline transactions with the POS terminal. After receiving the transaction record sent by the client phone, the payment server can check whether each transaction made by the card holder of the client phone has been sent through the POS terminal. If the POS terminal fails to send a few transaction records due to offline operation, the payment server may first store the transaction record sent by the client phone, and after receiving the transaction record of the card holder that has not previously been uploaded by the POS terminal, payment server can then compare the transaction records in the future. If all transactions made by the card holder have been sent by the POS terminal, the payment server can compare the transaction record sent by the client phone with the transaction record sent by the POS terminal. If it is confirmed that there is no conflict between the two sets of transaction records, a new transaction token can be generated. This new transaction token may include a new expiry date.

Therefore, the embodiment can implement the function of offline top-up, and the client phone can complete the top-up without the network connection.

In addition, in some embodiments, the offline top-up function can be implemented without the presence of POS terminal, and the client phone can complete the top-up when the top-up merchant does not have the terminal. details as follows:

The cardholder gives the cash and the card number to be top-up to the merchant who is eligible to perform top-up transaction; the merchant uses his own computer or mobile phone to log in to the merchant virtual card top-up platform, enters the top-up amount and the card number; after the platform server processes the data, the POS terminal can downloads the latest top-up command list from the server and stores the top-up command list in the top-up command list memory module 105.

Thus, when the card holder makes a consumer transaction with any POS terminal through the client phone, the POS terminal can search for the top-up command from the top-up command list memory module 105. If the POS terminal has found the top-up command belonging to the virtual card ID of the client phone, the top-up action is completed simultaneously in the same communication session with the consumer transaction. That is, the balance of the wallet in the client phone is updated.

In some embodiments, in the offline case, if the transaction record of the client device not present top-up transaction is not sent to the payment server in time, it is likely to cause repeated execution of the same top-up command. In order to avoid this circumstance, the POS terminal can prevent the same top-up command from being executed multiple times by comparing the value of the virtual card's client device not present top-up counter RCounter. That is, each top-up command can only be executed once. When performing the client device not present top-up, the client phone can write the client device not present top-up counter into the latest transaction record and store it in the memory module of the client phone. When the next transaction is performed, the POS terminal compares the RCounter in the transaction record sent by the client phone with the RCounter in the top-up command stored in the POS terminal to determine whether or not to execute the top-up command. If the former is greater than or equal to the latter, it indicates that the relevant top-up command has been executed and needs not to be executed.

Combining the above technologies, the present invention can quickly lay out a payment platform in a country where the communication network is not well developed:
1, through the two-way transmission of two-dimensional code and Bluetooth, to ensure that Bluetooth is connected to the correct client phone, to avoid doing transaction with a wrong device. And since most mobile phones are equipped with Bluetooth, the present invention is applicable to almost all current mobile phones. It greatly increases the adoption rate of the payment system using this technology.
2. Since the transaction token and the transaction record recorded in a general ledger can be recorded in the memory module of the client phone, and the transaction token can include a expiry date, with the present invention, the mobile phone can perform multiple offline transactions in a place where the communication network is not good before the expiry date.
3. In some underdeveloped countries, since the communication network is not well developed, the popularity rate of the bank account is low, and the price of the POS terminal is relatively high compared to the local people's income, the present invention provides a function for client device not present top-up, which allows the merchant to top-up the customer's account with a normal computer or mobile phone without a POS terminal. That is, the present invention is advantageous for quickly laying out top-up points for the convenience of users.
4. In case of offline operation, if the transaction record of the hands-free offline top-up is not sent to the payment server in time, it is likely to cause repeated execution of a top-up command. Therefore, the POS terminal can prevent the same top-up command from being executed more than once by comparing the value of the RCounter corresponding to the virtual card. This ensures the security of top-up.
5. Using an expiry date in the transaction token, it is ensured that the client phone often checks the transaction record with the server to update the transaction token, thereby increasing the credibility of the transaction token recorded in memory module of the client phone.
6. The transaction record is sent by the client phone and the POS terminal to the payment server, which can effectively prevent the transaction record from being lost due to the failure of the POS terminal. Moreover, the transaction records of the two sides can also be compared with each other so that the problematic transaction records can be found for follow-up and correction. In this way, it can effectively detect replay attacks caused by any client phone tampering with the file system.
7. The transaction token can be added to a generation time and a comprehensive credit value. And, when trading a relatively large transaction amount, the POS terminal can request the client phone to provide a transaction token with a relatively new generation time, or a user with a higher comprehensive credit value, thereby increasing the security of the large amount transaction.

Obtaining Transaction Token:

The case of obtaining the transaction token may include the following: The new user obtains the transaction token while registering, the existing user obtains the transaction token while logging in, and the client phone checks the transaction record and updates the transaction token from time to time, etc.

The method for obtaining a transaction token in various cases is similar, and may include the following steps:
In step T1, the user enters a username and a password on the client phone.
In step T2, the client phone can randomly generate a challenge Nc and a session key, and encrypt the two using the public key of the payment server. The encrypted data is then sent over the Internet to the payment server. The transmission channel used to transmit the randomly generated challenge Nc and the session key may include: the communication link of WAP (Wireless Application Protocol), CDMA (Code Division Multiple Access), Wi-Fi, WIMAX (Worldwide Interoperability for Microwave Access, WCDMA (Wide Band Code Division Multiple Access), TD-CDMA (Time Division-Synchronous Code Division Multiple Access), CDMA2000, etc.
In step T3, the payment server decrypts the message sent by the client phone with its own private key, and then signs the verifier Nc sent by the client phone with its own private key, and adds the signed challenge Nc. to the challenge Ns randomly generated by the payment server. Finally, the processed challenge Ns is encrypted by the session key sent by the client phone, and the encrypted challenge Ns is sent to the client phone.
In step T4, after receiving the reply sent by the payment server, the client phone decrypts the reply with the session key and generates a login request. The login request may include: a challenge Ns, a user name, a hashed password processed by a hash function Hash(Password), a card number Card ID, a device number Device ID, and a transaction record list Transaction List. The client phone then encrypts the login request with the session key and sends the encrypted login request to the payment server. Among them, if is a case of new user registration or a logging of existing user, a card number is randomly generated, and the card number used in the transaction is added in the login request. If is a case of the transaction record being checked and the transaction token being updated, the existing card number Card ID is added to the login request. If it is a case of the transaction record being checked and the transaction token being updated, the transaction record list TransactionList records all transactions that have been made since the transaction token was last received. If a new user registers or an existing user login, the transaction record list TransactionList is empty.
In step T5, after receiving the login request, the payment server first decrypts the request with the session key, and then checks the related user name and the hashed password Hash (Password). If it is determined that the current login request is a command to check the transaction record and update the transaction token, according to the card number Card ID, the server may extract the transaction record list previously received from the POS terminal. The server then compares the transaction record list TransactionList received from the client phone with the extracted transaction record list. If the comparison result is correct, the following message is generated: Ns+1, a transaction token Token, and the signature of the token SIGNpos(Token). Among them, Ns+1 is the value of the challenge Ns plus one, which can prevent replay attacks. The transaction token includes a device number Device ID, a card number Card ID, a virtual card balance Bal, a transaction counter TCounter, a client device not present top-up counter RCounter, and a expiry date of the transaction token TokenValidity. The transaction token is recorded in the memory module of the client phone. The SIGNpos(Token) can be obtained by signing the Token with the private key stored in the secure element 101 of the POS terminal. The message that aggregates Ns+1, the transaction token Token and the SIGNpos(Token) is encrypted with the session key and sent to the client phone. In the case of a new user registration, the value of the virtual card balance Bal, the transaction counter TCounter, and the client device not present top-up counter RCounter in the transaction token Token are all 0. If the old user logs in or checks the transaction record and updates the transaction token, the virtual card balance Bal, the cumulative count of transactions TCounter, and the client device not present top-up counter RCounter are the existing values of the virtual card. If the old user logs in, the card number is randomly generated by the client phone, and the card number of the original old virtual card is added to the blacklist.

In the case of checking the transaction record and updating the transaction token, after receiving the transaction record list TransactionList, the payment server can check whether each transaction in the transaction record list TransactionList has been sent by the POS terminal. If yes, the comparison is made. If the POS terminal fails to send several transaction records due to offline operation, the payment server may first store the transaction record list TransactionList sent by the client phone, and when transaction records mentioned above is sent from the POS terminal, the comparison can then be made. By confirming that there is no conflict between the transaction records sent by the POS terminal and the transaction records sent by the client phone, a new transaction token can be generated for step T6.

In the case where the new user is registered and the existing user is logged in (ie, the old user is logged in), the transaction record is no need to be checked in step T5, and step T6 is directly performed.
In step T6, the client phone decrypts the message fed back by the payment server by using the session key. The relevant transaction token Token and its signature SIGNpos(Token) are stored to the memory module 203.

The information transfer process of the above communication session can be expressed in the following ways:
C->S:PEs(Nc, KEYc)
S->C:Ec(Ns, SIGNs(Nc))
C->S:Ec(Ns, User Name, Hash(Password), Card ID, Device ID, TransactionList)
S->C:Ec(Ns+1, Token={Device ID, Card ID, Bal, TCounter, RCounter, TokenValidity}SIGNpos(Token))

wherein:
C represents a client phone, and S represents a payment server;
PEs indicate encryption with S's public key;
KEYc represents the session key randomly generated by C;
Ec indicates that the session key is randomly generated by C;
SIGNs means signing with S's private key;
SIGNpos means signing with the private key stored in the secure element (101) of the POS terminal;
Nc represents the challenge generated by C (randomly generated);
Ns represents the challenge generated by S (randomly generated);
Card ID indicates the card number of the virtual card in the client phone; if the new user registers and the existing user logs in, the Card ID is randomly generated; if the transaction record is checked and the transaction token is updated, the Card ID is the card number currently saved in the client phone;
Device ID indicates the machine number of the client phone, which may be the IMEI (International Mobile Equipment Identity) on the SIM card;
User Name represents the username;
Hash (Password) represents the user's password processed by a hash function;
Token indicates the transaction token;
Bal represents the balance of the virtual card;
TCounter represents the transaction counter virtual card;
RCounter represents the client device not present top-up count;
TokenValidity represents the expiry date of the transaction token;
TransactionList represents the transaction record list recorded in the memory module of the client phone.

POS Terminal Transaction:

In the case of consumer transactions, the transactions between a client phone and a POS terminal include the following steps:
Step P1: Before the client phone and the POS terminal perform the transaction, the client phone may obtain the transaction token Token and the signature SIGNpos(Token) of the token from the transaction platform server in advance according to the steps T1 to T7 mentioned above, and empty transaction ledger. Once the transaction token has been downloaded, transactions can be performed between the client phone and the POS terminal without network with the transaction platform server until the transaction token expire.
Step P2: During the transaction, the client phone generates a two-dimensional code. The information provided in the two-dimensional code includes the following: the latest transaction token Token saved by the client phone and its signature SIGNpos(Token), the last transaction record of the transaction ledger Transaction n and its signature SIGNpos (Transaction n), a timestamp and a challenge randomly generated. The signatures are all signed by the private key in the secure element of the POS terminal. The information provided by the two-dimensional code can be pre-encrypted by using the public key in the secure element of the POS terminal, and then presented in the form of a two-dimensional code in the interface of the client phone after being encrypted.

If the client phone just downloads a new transaction token from the payment server before the transaction, the token can reflect the latest transaction data. Thus, the last transaction record Transaction n and the signature SIGNpos(Transaction n) of this transaction record are empty.

After the two-dimensional code is displayed on the client phone, the client phone waits for Bluetooth answer. And, every few seconds or a preset time, the client phone can update the timestamp in the above two-dimensional code, and encrypt the foregoing information in the same manner, and then display the content in the form of a two-dimensional code. In this way, the POS terminal prevents replay attacks by checking the timestamp.
Step P3: The POS terminal scans the two-dimensional code displayed on the client phone through the two-dimensional code scanner (103), and decrypts the scanned information of the two-dimensional code by the private key stored in the POS terminal secure element (101). Then, check the timestamp within the message. If the value of the timestamp meets the set requirements, for example, the time lag between the current time and the timestamp is within the set time difference threshold, the POS terminal re-signs the transaction token Token using the private key stored in the POS terminal secure element (101). And compares the signed transaction token Token with the signature SIGNpos(Token) of the received transaction token Token. If the comparison shows two data match each other, continue with the following steps.
Step P4: The POS terminal checks whether the card number card ID included in the transaction token is in the blacklist, whether the validity TokenValidity is expired, and whether the balance is sufficient for the transaction. If each check passes, continue with the following steps.
Step P5: The POS terminal sends the following message to the client phone with low Bluetooth low energy: the new transaction record Transaction n+1 and its signature, and the signed challenge Nc randomly generated by the client phone. This message is encrypted with the session key of the client phone before it is sent. wherein, the signature of the new transaction record SIGNpos (Transaction n+1) is signed by private key in the secure element of the POS terminal. The signed challenge Nc is signed using the private key in the secure element within the POS terminal. The information recorded in the above transaction record includes: transaction type code Type (for example, purchase transaction), current transaction amount Amount, transaction counter TCounter (value is n+1), the value of client device not present top-up count RCounter (its value is maintained as that in the last transaction record) and the virtual card balance Bal (its value should be the virtual card balance Bal of the last transaction record minus transaction amount Amount).
Step P6: After receiving the message sent by the POS terminal through the Bluetooth, the client phone decrypts the message by the session key, and checks whether the signature of the challenge Nc that is SIGNpos(Nc) is correct. If it is correct, the new transaction record Transaction n+1 is added to the memory module of the client phone. The result of the transaction Resultcp is displayed in the form of a two-dimensional code. wherein, the transaction result Resultcp is encrypted by the session key.
Step P7: The POS terminal scans the transaction result displayed by the client phone by the two-dimensional code scanner (103). The scanned transaction result is decrypted by the session key. If the scanned Resultcp is a code for successful transaction, the transaction result Resultpc encrypted by the session key is transmitted via Bluetooth. The value of Resultpc is the code for the successful transaction.

The above communication session can be expressed in the following ways:
C->P:PEp(Token, SIGNpos(Token), Transaction n, SIGNpos(Transaction n), TimeStamp, Nc, KEYc)
P->C:Ec(Transaction n+1, SIGN(Transaction n+1), SIGNpos(Nc))
C->P:Ec(Resultcp)
P->C:Ec(Resultpc)
Wherein, C represents a client phone;
P represents a POS terminal;
PEp indicates encryption with P's public key;
Token indicates the transaction token;
SIGNpos means signing with the private key stored in the secure element (101) of the POS terminal;
Nc represents the challenge generated by C (randomly generated);
Transaction n represents a transaction where the value of TCounter is n; Transaction n+1 represents a transaction where the value of TCounter is n+1, and so on;
Transaction n includes: transaction type code Type, a transaction amount Amount, a cumulative count of transactions of the virtual card TCounter (value is n), a client device not present top-up count RCounter, the virtual card balance Bal;
TimeStamp represents a current timestamp;
KEYc represents the session key randomly generated by C;
Ec represent the encryption operation using that the session key C;
Resultcp represents the transaction result code transmitted by C to P;
Resultpc represents the transaction result code transmitted by P to C.

In some embodiments, the above two-dimensional code may further include a reply message address. The value of this address can be randomly generated. The client phone while showing the two-dimensional code also scans the message packet with the above address in the Bluetooth broadcast message. In this way, the client phone can select a message related to the transaction from a plurality of Bluetooth broadcast messages.

In some embodiments, when the POS terminal feedbacks a message to the client phone, the POS terminal can transmit the message by using the Bluetooth broadcast message packet carrying the address, without making a low-power Bluetooth connection with the client phone. This saves the time of Bluetooth connection and speeds up the transaction.

In some embodiments, if the length of the feedback message exceeds the length limit of a Bluetooth broadcast message packet, the POS terminal divides the feedback message into multiple segments, and adds a sequence number to the message packet to identify the segment of the message packet in the feedback message. The transmission is repeated in turn by multiple Bluetooth broadcast packets until it is scanned from the two-dimensional code scanner to the transaction confirmation message displayed on the client phone. When the client phone scans the Bluetooth broadcast message, the above-mentioned feedback message is reorganized through the above sequence number. This design can efficiently transmit messages close to 140 bytes in about 1.5 seconds. Also, it can avoid transaction failures and delays caused by Bluetooth connection failures. The embodiment of the invention significantly improves the transaction speed and stability of the Android mobile phone as a client mobile phone.

Client Device not Present Top-Up:

The top-up method provided by the invention aims to realize the function of the client device not present top-up, and can complete the top-up in the case that the client phone has no network, even in the case that the top-up merchant has no terminal.

When the cardholder performs the client device not present top-up, the cardholder can hand over the cash and card number to the top-up merchant. Merchants use their own computers or mobile phones to log in to virtual card top-up platform of the merchant and enter the top-up amount and card number to top-up. The relevant operation after inputting the top-up amount and the card number can be implemented by the following session one.

After the payment server handles the data, the POS terminal downloads the latest top-up command list from the payment server, and stores the top-up command list in the top-up command list memory module 105. The steps are implemented by the following session two.

When the client phone performs a purchase transaction at any POS terminal, the POS terminal searches for the top-up command from the top-up command list memory module 105. If a top-up command corresponding to virtual card number of the client phone is found, the top-up is simultaneously performed in the same communication session with the consumer transaction. The steps are implemented by the following three sessions.

In the offline case, if the transaction record of the hands-free offline top-up is not sent to the payment server in time, it may cause a top-up command to be executed more than once. In order to avoid this situation, the POS terminal can prevent the same top-up command from being executed more than once by comparing client not present top-up counter without machine RCounter of the virtual card in the client phone. When performing the hands-free offline top-up, the POS terminal writes the offline top-up count without machine into the latest transaction record and stores it in the memory module of the client phone. When the transaction is to be performed next time, the POS terminal compares the RCounter in the transaction record sent by the client phone with the RCounter of the corresponding top-up command stored in the POS terminal. If the former is greater than or equal to the latter, it indicates that the top-up command has been executed and the command will not be executed repeatedly. In the offline case, the POS terminal can prevent the same top-up command from being executed more than once by comparing the value of the RCounter.

Session One:
B->S: cardID, TopUpAmount

Session Two:
P->S: GetTopUpUpdate
S->P: TopupCmdList=cardID, TopUpAmount, RCounter

Session Three:
C->P: PEp(Token, SIGNpos(Token), Transaction n, SIGNpos(Transaction n), TimeStamp, Nc, KEYc)
P->C:Ec(Transaction n+1, SIGN(Transaction n+1), SIGNpos(Nc));
C->P: Ec(Resultcp);
P->C:Ec(Transaction n+2, SIGN(Transaction n+2), SIGNpos(Nc));
C->P: Ec(Resultcp);
P->C: Ec(Resultpc);
Resultcp represents the transaction result code transmitted by C to P;
Resultpc represents the transaction result code transmitted by P to C.

The communication of the hands-free offline top-up includes the following steps:
Step PR1: Before the client phone makes a transaction with the POS terminal, the client phone obtains the transaction token and the signature SIGNpos (Token) of the token according to steps T1 to T6 in advance, and clears the transaction ledger. Once the transaction token has been downloaded, the transaction may continue until the transaction token expires. In this way, it is possible to download the transaction token without having to trade each time.
Step PR2: When the transaction is performed, the client phone generates a two-dimensional code and displays the two-dimensional code. The information provided by the two-dimensional code includes: the latest transaction token Token saved by the client phone and its signature SIGNpos (Token), the last transaction record of the transaction ledger Transaction n and its signature SIGNpos (Transaction n), timestamp, the challenge resulted randomly. This information is concatenated and encrypted by the public key in the POS terminal secure element. The last transaction record Transaction n of the transaction ledger is signed by the private key in the secure element of the POS terminal, and the obtained signature is SIGNpos(Transaction n).

If the client phone just downloads a new transaction token from the payment server before the transaction, the token can reflect the latest transaction data. Thus, the last transaction record Transaction n and the signature SIGNpos(Transaction n) of this transaction record are empty. And, the client phone updates the timestamp of the above two-dimensional code every few seconds or a preset time, and encrypts the serialized information in the same manner, and then displays the information in the form of a two-dimensional code. In this way, the POS terminal can prevent replay attacks by checking the timestamp.
Step PR3: The POS terminal scans the two-dimensional code displayed on the client phone by the two-dimensional code scanner (103). First, the scanned message is checked, and the scanned message is decrypted with the private key stored in the POS terminal secure element (101). Then, the timestamp in the scanned message is checked. If the value of the timestamp is close enough to the current time, the POS terminal then uses the private key stored in the POS terminal secure element (101) to sign the transaction token Token. The signed data is compared with the signature SIGNpos (Token) of the transaction token in the scanned message. If the comparison result is that the two pieces of data match each other, continue with the following steps.
Step PR4: The POS terminal first checks whether the CardID in the signature of the transaction token is in the blacklist. If it is not in the blacklist, check if the expiry date TokenValidity has expired. If the current time is earlier than the expiry date TokenValidity, the top-up command memory module 105 of the POS terminal finds the top-up command of the card, and the POS terminal compares the RCounter of the top-up command found in the top-up command memory module 105 and the RCounter of the card in the scanned message. If the former is less than or equal to the latter, it indicates that the top-up command has been executed. If the former is greater than the latter, the top-up is to perform. Thereby, it can prevent a top-up command from being executed repeatedly. After top-up, check if the sum of the balance and the top-up amount is sufficient to perform the consumer transaction. If yes, continue with the following steps. If the RCounter of the top-up command is less than or equal to the RCounter of the virtual card, indicating that the relevant top-up command has been executed, then go to step PR5 in the POS terminal transaction.
Step PR5: The POS terminal sends the following message to the client phone with low power Bluetooth, and the message includes the following: a new transaction record Transaction n+1 and its signature, and a signed challenge Nc randomly generated by the client phone. This message is encrypted using the session key Ec of the client phone before being sent. Wherein, the signature SIGNpos (Transaction n+1) of the new transaction record is signed by the private key in the secure element of the POS terminal corresponding to the new transaction record. The data recorded in the above transaction record may include: transaction type Type (which is the top-up code), the current transaction amount Amount (which is the top-up amount of the top-up command TopUpAmount), and transaction counter TCounter (the value is n+1)) of the virtual card, client device not present top-up counter RCounter (which is RCounter in the top-up command) of the virtual card, the virtual card balance Bal (which is the sum of the last transaction record's Bal and the top-up amount Amount).
Step PR6: After receiving the message sent by the POS terminal through the Bluetooth, the client phone decrypts the received message by using the session key of the client phone. Then, check whether the signature SIGNpos(Nc) of the challenge Nc is correct. If the signature is correct, the new transaction record Transaction n+1 and its signature SIGNpos (Transaction n+1) are written to the memory module 203 of the client phone. Finally, the transaction result Resultcp encrypted by the session key is sent in the form of a two-dimensional code, and the value of the transaction result is a code for successful top-up (transaction).
Step PR7: The POS terminal sends the following message via the Bluetooth low energy: the new transaction record Transaction n+2 and its signature, and the signed challenge Nc randomly generated by the client phone. This message is encrypted with the session key Ec before it is sent. Among them, the two signatures are all signed by the private key in the secure element of the POS terminal. The information of this transaction record may include: transaction type Type (which is the code of consumption), the current transaction amount (which is the consumption amount Amount), the transaction counter TCounter (the value is n+2) of the virtual card, the client device not present top-up counter RCounter, of the last transaction Record Transaction n+1, and the balance Bal (which should be the value after the balance Bal of Transaction n+1 minus the amount of the transaction Amount) of the virtual card.
Step PR8: After receiving the Bluetooth message, the client phone decrypts it with the session key. And the client phone checks whether the signature SIGNpos(Nc) of the challenge Nc is correct. If the signature is correct, the new transaction record Transaction n+2 and its signature SIGNpos (Transaction n+2) are written to the memory module 202 of the client phone. Finally, the transaction result Resultcp encrypted by the session key is sent in the form of a two-dimensional code, and its value is the code of the successful transaction.
Step PR9: The POS terminal scans the transaction result sent by the client phone and encrypted by the session key via the two-dimensional code scanner, and decrypts it with the session key. If the transaction result Resultcp is a successful transaction code, the transaction result Resultpc encrypted by the session key is sent to the client phone via the Bluetooth, and its value is the code of the successful transaction.

Wherein:
B represents a computer or mobile phone of a merchant responsible for top-up;
S represents a payment server;
P represents a POS terminal;
Card ID represents the card number of a virtual card to be top-up;
TopUpAmount represents the amount of top-up;
GetTopUpUpdate represents that a downloaded request of a top-up command list;
TopupCmdList represents a top-up command list;
RCounter requests the number of the hands-free offline top-up of the virtual card;
PEp requests encryption with the public key of the POS terminal;
Token requests the transaction token;
SIGNpos requests the signature of the private key stored in the POS terminal secure element (101);
Nc represents the challenge generated by C (randomly generated);
Transaction n represents a transaction where the value of TCounter is n; Transaction n+1 represents a transaction where the value of TCounter is n+1, and so on;
Transaction n contains: transaction type code (Type), transaction amount (Amount), cumulative count of transactions of the virtual card (TCounter=n), an offline top-up count without machine of the virtual card (RCounter), the virtual card balance (Bal);
Timestamp requests a current timestamp;
KEYc represents a session key randomly generated by C;
Ec represents the encryption operation using session key C.

The transmission channel in the session 1 is the Internet, and the merchant generally uses a computer or a mobile phone to log in to the merchant virtual card top-up module 301 in the payment server as a merchant. The merchant collects cash from the virtual card holder and then sends the merchant top-up command to the merchant virtual card top-up platform, including a card number and an amount. The virtual card corresponding to the card number can be displayed on the client phone in the form of a two-dimensional code, so that the merchant can scan by using the two-dimensional code scanner of the computer or the mobile phone. Also, the card number can be manually input.

After receiving the merchant top-up command, the merchant virtual card top-up module 301 first confirms whether the information in the instruction is correct. If correct, a system top-up command is generated and recorded in the memory module 302. The above system top-up commands include: a card number (Card ID), a top-up amount (TopUpAmount) and an offline top-up count without machine of the virtual card (RCounter). The value of RCounter is the maximum value of the offline top-up count without machine of the card (RCounter) plus one.

The payment server places the top-up command that has not been executed into the memory module 302. The POS terminal periodically downloads the updated top-up list from the payment server.

As described in session 2, the POS terminal periodically sends a download request for a top-up command list (GetTopUpUpdate) to the payment server via the Internet, and the payment server returns the top-up command list (TopupCmdList) to the POS terminal after receiving the request. After receiving the above top-up command list, the POS terminal stores it in the memory module 105 for storing top-up commands of the POS terminal.

As mentioned in Session 3: When the cardholder makes the next purchase through the client phone, it can simultaneously top-up and consume in the same transaction, saving the time and effort.

Referring to FIG. 5, an embodiment of the present invention provides a method for offline transaction, which is executed by a client device, and includes the following steps:
S110, obtaining a transaction token in advance from a payment server, wherein the transaction token includes an expiry date.
S120, displaying a code for transaction for the POS terminal to scan the code when the transaction is performed with the POS terminal; the code includes the transaction token and a last transaction record.
S130, receiving a new transaction record via Bluetooth, sent by the POS terminal; wherein the new transaction record is generated by the POS terminal according to the transaction amount and the last transaction record after verifying that the transaction token is in a valid state; the valid state includes the expiry date being later than the current time.
S140, storing the new transaction record for perform the next transaction with a POS terminal.

In some embodiments, the transaction record includes a virtual card balance and a transaction counter. The new transaction record is generated by the POS terminal according to the virtual card balance and the cumulative count of transactions in the last transaction record and the transaction amount, after verifying that the transaction token is valid.

In some embodiments, the transaction token further includes a virtual card balance and a transaction counter. The method further comprises: clearing the transaction record stored in the client device while receiving the transaction token. In case that the last transaction record is empty, the new transaction record is generated by the POS terminal according to the virtual card balance and the cumulative count of transactions included in the transaction token and the transaction amount, after verifying that the transaction token is valid.

In some embodiments, the method further includes obtaining a new transaction token as follows:

Transmitting a transaction record list to the payment server; wherein the transaction record list includes all transaction records performed by the client device and the POS terminal after receiving the transaction token; the transaction list is configured to compare with all of the transaction records uploaded by the POS terminal to the payment server. Receiving a new transaction token sent by the payment server. The new transaction token is generated in a case where the comparison does not conflict, and the new transaction token includes a new expiry date, the new expiry date is later than the current time.

In some embodiments, the transaction token includes a virtual card ID of the client device, and the transaction record includes an client device not present top-up counter, the method further comprising:

First, receiving a top-up transaction record sent by the POS terminal before receiving the top-up transaction record sent by the POS terminal; wherein the top-up transaction record is generated by the POS terminal according to the top-up amount of the top-up command and the last transaction record after the POS terminal verifies that the transaction token is valid and the client device not present top-up counter of the top-up command corresponding to the virtual card found by the POS terminal is greater than the client device not present top-up counter recorded in the last transaction record; the top-up command is downloaded by the POS terminal from the payment server, and is generated while a card holder of the client device logs in the payment server through the merchant device for top-up; the value of the client device not present top-up counter of the top-up transaction record is the value of the client device not present top-up counter of the top-up command.

Second, storing the top-up transaction record and transmitting a successful top-up result to the POS terminal to receive the new transaction record; wherein the last transaction record recorded by the POS terminal is updated to the top-up transaction record.

In some embodiments, the transaction token includes a comprehensive credit value; the comprehensive credit value is configured to determine whether to generate a new transaction record by the POS terminal when the transaction amount is greater than a set transaction amount threshold.

In some embodiments, the transaction token further includes a generation time. The generation time is configured to determine whether to generate the new transaction record by the POS terminal when the transaction amount is greater than a set transaction amount threshold wherein the generation time is used to generate, according to the transaction token, when the transaction amount is greater than a set transaction amount threshold Time to decide whether to generate the new transaction record.

In some embodiments, the two-dimensional code further includes a reply message address, and the receiving a new transaction record via Bluetooth sent by the POS terminal comprises:
scanning a Bluetooth broadcast message and obtaining a message packet containing the address of the reply message;
obtaining a new transaction record sent by the POS terminal from the message packet.

In some embodiments, the obtaining a new transaction record sent by the POS terminal from the message packet comprises:
Reassembling the obtained message packet according to the sequence number of the obtained message packet;
Obtaining a new transaction record sent by the POS terminal, from the reassembled message packet.

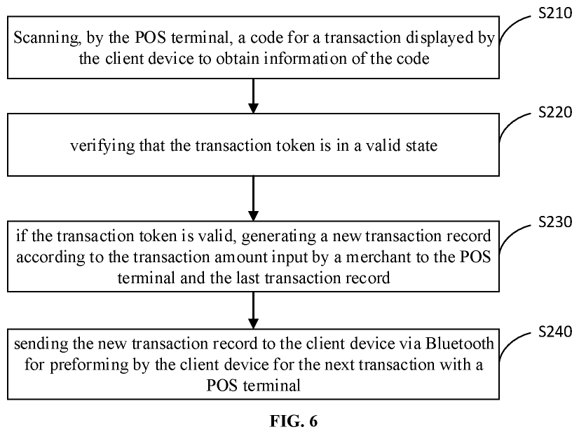

Referring to FIG. 6, an embodiment of the present invention provides a method for offline transaction, which is executed by a POS terminal, and includes the following steps:
S210: scanning, by the POS terminal, a code for a transaction displayed by the client device to obtain information of the code; wherein the information of the code includes a transaction token and a last transaction record, the transaction token is obtained by the client device in advance from a payment server, and the transaction token includes an expiry date.
S220: verifying that the transaction token is in a valid state.
S230: if the transaction token is valid, generating a new transaction record according to the transaction amount input by a merchant to the POS terminal and the last transaction record; wherein the valid state includes that the expiry date is later than the current time.
S240: sending the new transaction record to the client device via Bluetooth for the client device to perform next transaction with a POS terminal.

In some embodiments, the transaction record includes a virtual card balance and a transaction counter, and the generating a new transaction record according to the transaction amount input by a merchant to the POS terminal and the last transaction record. It comprises the following steps:

Subtracting the transaction amount from the virtual card balance in the last transaction record to obtain a virtual card balance of the new transaction record.

The transaction counter in the last transaction record is incremented by one to obtain the cumulative count of transactions of the new transaction record.

In some embodiments, the transaction token further includes a virtual card balance and a cumulative count of transactions, the generating a new transaction record according to the transaction amount input by a merchant to the POS terminal and the last transaction record comprises:
verify that the last transaction record is empty;
if the last transaction record is empty, generating a new transaction record according to the virtual card balance and the cumulative counter of transactions included in the transaction token, and the transaction amount.

In some embodiments, the method comprises:
Uploading the new transaction record to the payment server for storing a transaction record set corresponding to the client device; the transaction record set includes transaction records performed by the client device and the POS terminal uploaded by the POS terminal after the payment server sends the transaction token to the client device; The purpose of the transaction record set is to facilitate the payment server to compare them with the transaction record sent from the POS terminal, and generating, by the payment server, a new transaction token for transmission to the client device if the there is no conflict found during the comparison; the new transaction token includes a new expiry date, the new expiry date is later than the current time.

In some embodiments, the method further comprises: downloading a top-up command from the payment server; wherein the top-up command is generated while a card holder of the client device logs in the payment server for top-up; and the top-up command includes a top-up amount, a virtual card ID and an client device not present top-up counter.

In some embodiments, the transaction token includes a virtual card ID of the client device, and the transaction record includes a client device not present top-up counter of the virtual card. The method may further include:

First, after the POS terminal verifies that the transaction token is valid, searching for a top-up command of the virtual card according to the virtual card ID.

Then, if the client device not present top-up counter of the top-up command is greater than the client device not present top-up counter recorded in the last transaction record, generating a top-up transaction record according to the top-up amount of the top-up command and the last transaction record obtained from the client device; wherein, the value of the client device not present top-up counter of the top-up transaction record is the value of the offline top-up count without machine of the top-up command.

Furthermore, updating the last transaction record to the top-up transaction record.

In some embodiments, the transaction record includes a virtual card balance and a transaction counter. And the generated a top-up transaction record according to the top-up amount of the top-up command and the last transaction record obtained from the client device comprises:
adding the top-up amount to the virtual card balance in the last transaction record to obtain a virtual card balance of the new transaction record; and
Incrementing the transaction counter in the last transaction record by one to obtain a cumulative count of transactions of the new transaction record.

In some embodiments, the transaction token includes a comprehensive credit value; the method further comprises:

If the transaction amount is greater than a preset transaction amount threshold, determining whether to generate a new transaction record according to the comprehensive credit value.

In some embodiments, the transaction token further includes a generation time; the method further comprises:
If the transaction amount is greater than the preset transaction amount threshold, determining whether to generate the new transaction record according to the generation time of the transaction token.

In some embodiments, the two-dimensional code further includes a reply message address, and the sending the new transaction record to the client device via Bluetooth comprises:
generating a message packet according to the reply message address and the new transaction record; and
sending the message packet by a Bluetooth broadcast message.

In some embodiments, the sending the message packet by a Bluetooth broadcast message comprises:
dividing the message packet into a plurality of message packets; and the divided message packet includes a sequence number, and the sequence number is configured to identify the segment that the message of the divided message packet is in the message of the message packet before divided; and
sending the plurality of message packets by a Bluetooth broadcast message.

Referring to FIG. 2, a client device provided by an embodiment of the present invention comprises:
a memory module, configured to store a transaction token obtained in advance from a payment server; wherein the transaction token includes a expiry date;
a display screen, configured to display a code for transaction for the POS terminal to scan the code when the transaction is performed with the POS terminal; the code includes the transaction token and the last transaction recording;
a Bluetooth module, configured to receive a new transaction record sent by the POS terminal; wherein the new transaction record is generated by the POS terminal according to the transaction amount and the last transaction record after verifying that the transaction token is in a valid state; the valid state includes the current time being earlier than the expiry date;
the memory module, further configured to store the new transaction record for perform the next transaction with a POS terminal.

Referring to FIG. 1, an embodiment of the present invention provides a POS terminal, comprising:
a two-dimensional code scanner, configured to scan a code for a transaction displayed by the client device to obtain information of the code; wherein the information of the code includes a transaction token and a last transaction record, the transaction token is obtained by the client device in advance from a payment server, and the transaction token includes a expiry date;
a processor, configured to verify that the transaction token is in a valid state; if the transaction token is valid, generates a new transaction record according to the transaction amount input by a merchant to the POS terminal and the last transaction record; wherein the valid state includes that the current time being earlier than the expiry date;
a Bluetooth module, configured to send the new transaction record to the client device for the client device to perform next transaction with a POS terminal.

In some embodiments, the POS terminal further includes:
a payment server communication module, configured to upload the new transaction record to the payment server to store a transaction record set corresponding to the client device;
the transaction record set includes all the transactions done after the client device receiving the transaction token from payment server, The purpose of the transaction record set is to facilitate the payment server to compare them with the transaction record sent from the POS terminal, and generating, by the payment server, a new transaction token for transmission to the client device if the there is no conflict found during the comparison; the new transaction token includes a new expiry date, the current time is earlier than the new expiry date.

The payment server communication module, further configured to download a top-up command from the payment server, wherein the top-up command is generated while a card holder of the client device logs in the payment server for top-up, and the top-up command includes a top-up amount, a virtual card ID and an client device not present top-up counter; and a top-up command memory module, configured to store the top-up command.

What is claimed is:

1. A method for offline transaction, comprising:
receiving a transaction token, by a client device, from a payment server, wherein the transaction token comprises an expiry date;
scanning, by a POS terminal, a code for a transaction displayed by the client device, and obtaining, by the POS terminal, information of the code, wherein the information of the code includes the transaction token and a last transaction record, wherein the last transaction record indicates a virtual card balance and a transaction counter in a last transaction;
verifying, by the POS terminal, that the expiry date of the transaction token is later than a current time;
generating, by the POS terminal, a new transaction record according to the transaction amount input by a merchant to the POS terminal and the last transaction record based upon the expiry date of the transaction token being later than the current time, wherein the new transaction record indicates the virtual card balance and the transaction counter right after a last transaction indicated by the last transaction record;
sending, by the POS terminal, the new transaction record to the client device via a short distance wireless communication protocol such that the client device is capable of performing a next transaction with the POS terminal or another POS terminal;
uploading, by the POS terminal, the new transaction record to the payment server, and storing, by the payment server, a transaction record set corresponding to the client device, wherein the transaction record set includes transaction records performed by the client device and the POS terminal uploaded by the POS terminal after the payment server sends the transaction token to the client device;
sending, by the client device, the transaction record list to the payment server;
comparing, by the payment server, the transaction record set with the transaction record list;
determining, by the payment server, that there is no conflict between the transaction record set and the transaction record list;
generating, by the payment server, a new transaction token for transmission to the client device, wherein the new transaction token includes a new expiry date, wherein the new expiry date is later than the current time; and transmitting, by the payment server, the new transaction token to the client device.

2. The method according to claim 1, wherein the transaction token further comprises a virtual card balance and a transaction counter, the generating a new transaction record according to the transaction amount input by the merchant to the POS terminal and the last transaction record comprises:
verifying that the last transaction record is empty;
generating a new transaction record according to the virtual card balance and the cumulative counter of transactions included in the transaction token, and the transaction amount based upon the last transaction record being empty.

3. The method according to claim 1, wherein the method further comprises:
downloading a top-up command from the payment server; wherein the top-up command includes a top-up amount, a virtual card ID and a client device not present top-up counter.

4. The method according to claim 3, wherein the transaction token further comprises a virtual card ID of the client device, the transaction record comprises a client device not present top-up counter, the method also comprises:
after the POS terminal verifies that the transaction token is valid, searching for a top-up command of the virtual card according to the virtual card ID;
generating a top-up transaction record according to the top-up amount of the top-up command and the last transaction record obtained from the client device when the client device not present top-up counter of the top-up command is greater than the client device not present top-up counter recorded in the last transaction record; wherein, the value of the client device not present top-up counter of the top-up transaction record is the value of the client device not present top-up counter of the top-up command;
updating the last transaction record to the top-up transaction record.

5. The method according to claim 1, wherein the transaction token further includes a generation time of the transaction token; the method further comprises:
generating or not the new transaction record according to the generation time of the transaction token based upon the transaction amount being greater than a preset transaction amount threshold.

6. The method according to claim 1, wherein the information of the code further comprises a reply message address and the step of sending the new transaction record to the client device via a short distance wireless communication protocol comprises:
generating a message packet according to the reply message address and the new transaction record;
sending the message packet by a short distance wireless communication protocol broadcast message.

7. The method according to claim 6, wherein the step of sending the message packet by a short distance wireless communication protocol broadcast message comprises:
dividing the message packet into a plurality of message packets, and the divided message packet includes a sequence number, and the sequence number is configured to identify the segment that the message of the divided message packet is in the message of the message packet before divided;
sending the plurality of message packets by the short distance wireless communication protocol broadcast message.
